(19) United States
(12) Patent Application Publication
(10) Pub. No.: US 2011/0309977 A1
(43) Pub. Date: Dec. 22, 2011

(54) POWER REDUCTION IN WIRELESS APPLICATIONS

(75) Inventors: Thomas Howard Daugherty, JR., Lantana, TX (US); Scott Douglas Constien, Plano, TX (US); Charles Chapman Moore, Plano, TX (US)

(73) Assignee: Enfora, Inc., Richardson, TX (US)

(21) Appl. No.: 13/164,663

(22) Filed: Jun. 20, 2011

Related U.S. Application Data
(60) Provisional application No. 61/356,423, filed on Jun. 18, 2010.

(51) Int. Cl. G01S 19/42; H04B 7/00; G01S 19/34

(52) U.S. Cl. 342/357.25; 342/357.74; 455/232.1

(57) ABSTRACT

A mobile tracking device is provided that monitors or measures one or more signals from GPS satellites and remote wireless base stations during a GPS acquisition process and a registration process, and terminates the process(es) prior to reaching a default timeout when the signals do not meet a predetermined threshold or value. Instead of continuing the acquisition and/or registration process for the full timeout period when the received signals (if any) indicate there is a low probability of successfully completing the particular process, the tracking device early terminates the process(es). This saves or reduces power by preventing the continued operation of the particular process when it is likely to be unsuccessful.

### CROSS-REFERENCE TO RELATED APPLICATION(S) AND CLAIM OF PRIORITY

The present application is related to U.S. Provisional Patent Application No. 61/356,423, filed Jun. 18, 2010, entitled “POWER REDUCTION IN WIRELESS APPLICATIONS”. U.S. Provisional Patent Application No. 61/356,423 is assigned to the assignee of the present application and is hereby incorporated by reference into the present application as if fully set forth herein. The present application hereby claims priority under 35 U.S.C. §119 to U.S. Provisional Patent Application No. 61/356,423.

### TECHNICAL FIELD

Generally, this disclosure relates to wireless data transmissions, and, more specifically, to the management and optimization of power usage of a mobile device.

### BACKGROUND

In mobile devices, battery powered devices often use periodic reporting to provide asset status and location. In this environment, the acquisition and registration process requires far more power than the actual transmission of information. Since this differs from the operational environment of consumer products, existing implementations do not attempt to address this problem.

### SUMMARY

In one embodiment, a method of reducing power consumption in a module within a mobile tracking device operable within a wireless communication network is provided. The method includes initiating a process performed by the module, the process configured for performing a predetermined operation within the mobile tracking device, the process configured with a default timeout period during which the module continues to attempt to perform the predetermined operation, measuring a parameter of a signal transmitted from a remote device during the process, comparing the measured parameter to a predetermined threshold, and determining that the measured parameter does not meet the predetermined threshold and terminating the process prior to the default timeout period.

In another embodiment, there is provided a method of reducing power consumption in a GPS module within a mobile tracking device operable within a wireless communication network. The method includes initiating a GPS signal acquisition process performed by the GPS module, where the process is configured for performing acquiring GPS signals and determining a location of the mobile tracking device, the process is further configured with a default timeout period during which the module continues to attempt to perform the predetermined operation. The method further determines within a first predetermined time interval if a first predetermined number of GPS satellite signals have been acquired, and if not, then the process is early terminated, and if so, the method determines within a second predetermined time interval if a second predetermined number of GPS satellite signals have been acquired, and if not, then the process is early terminated, and if so, the process is continued.

In yet another embodiment, there is provided a mobile tracking device having (1) a wireless network module having a wireless transceiver device configured for wirelessly communicating with a remote device, the wireless network module configured to perform a registration process operable for establishing a communication link with the remote device, and (2) a location generating module having a GPS receiver device configured for receiving GPS signals from one or more GPS satellites, the location generating module configured to perform a GPS signals acquisition process operable for acquiring multiple GPS signals and determining a location of the mobile tracking device therefrom. The mobile tracking device further includes a power optimization module configured to early terminate either the registration process or the GPS signals acquisition process based on at least one measured parameter of either a signal transmitted from the remote device during the registration process or a GPS signal transmitted from a GPS satellite during the GPS signals acquisition process, respectively.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a diagram of one system according to one embodiment of the present disclosure;

FIG. 2 is a flowchart of one method of acquiring data signals according to one embodiment of the present disclosure;

FIG. 3 is a flowchart of one method of acquiring navigation signals according to one embodiment of the present disclosure;

FIG. 4 is a diagram of a power optimization model for use in a mobile device according to one embodiment of the present disclosure;

FIG. 5 is a flowchart of one method of managing power according to one embodiment of the present disclosure; and

FIG. 6 is a flowchart of one method of managing power for a plurality of processes.

### DETAILED DESCRIPTION

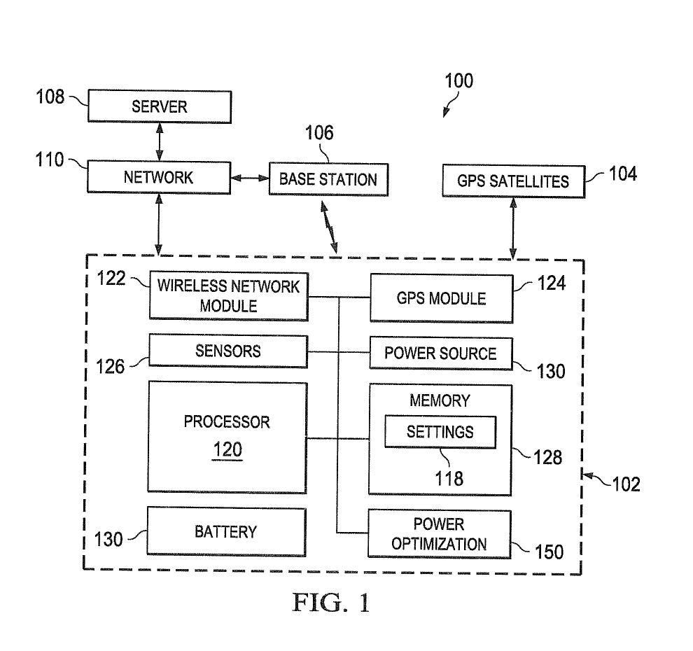

FIGS. 1 through 6, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

In particular scenarios, power consumption of a mobile device during signal acquisition can be relatively high. This power cost drains the limited resources of certain devices, such as a mobile tracking device. In particular applications, such as machine-to-machine (M2M) applications the battery drain caused by signal acquisition can be very high. In order to decrease this power demand, systems and methods are described that reduce power consumption in environments where data signals, such as Global System for Mobile Communications (GSM), are either absent or too weak for registration (e.g., establishment of a communication session or link). Systems and methods are also described that reduce power consumption in environments where navigation signals, such as global positioning system (GPS) signals, are either too weak, nonexistent, or not available from enough sources to successfully generate a navigation solution. Currently, both navigation and data communication processes result in waiting for a timeout before termination of the process, each with a default value which may be a number of minutes. During this time, a considerable amount of power may be consumed by the communications transceiver or GPS receiver of the mobile device.

Prior art attempts to address problems discussed herein have failed to address problems associated with power. Specifically, prior art implementations of the data communication and navigation processes of communication transceivers and GPS receivers fail to address factors such as device history, signal interference, partial signal availability, and battery life when performing reporting, tracking, and remote monitoring in remotely managed devices. One of the innovative elements of the present disclosure is the ability to minimize the expenditure of power in situations where there is a relatively low probability of successful signal acquisition (for data transmission or for a location fix).

FIG. 1 is a block diagram illustrating one system 100 in which the teachings and principles of the present disclosure may be incorporated (or utilized within) and are applicable for a battery-operated device. One example of such a battery-operated device is a Global Positioning System (GPS) mobile tracking device that has the ability to transmit GPS data over a wireless network. GPS data is used to determine the location of the battery-operated device (which is mounted or attached to equipment being monitored). In one specific example, the GPS tracking device includes a location/position module (for determining location/position information such as GPS data) and a wireless communications modem or radio (e.g., a Global System for Mobile/General Packet Radio Service (GSM/GPRS) module) to transmit the location information (e.g., GPS data) to a remote communications device (e.g., base station, host server). Through the combination of such a GPS module and the GSM/GPRS module, the GPS tracking device can both obtain GPS data as well as transmit the GPS data wirelessly to the remote device. Various GPS tracking devices may incorporate or include some of the methods and apparatus described herein, and a typical device suitable for modification and/or use with the methods and teachings herein is available from Enfora, Inc. (Richardson, Tex.) under different part/model numbers, including GSM 2228, GSM 2218 and GSM 2238.

Turning to FIG. 1, there is shown a block diagram of a GPS tracking system 100 that includes a GPS mobile tracking device or unit 102 and one or more GPS satellites 104. The system 100 also includes various remote communications devices, such as a base station 106 and a host server (or computer processing system) 108, that communicate with the GPS tracking device 102 through a telecommunications network 110. Though the embodiments described herein illustrate an example GPS tracking device 102, the methods and apparatus described herein may be applied to, or utilized with, other battery-operated devices. For tracking or monitoring equipment (or other environmental attributes in the location of the equipment), the device 102 is adapted for mounting to or inclusion in such equipment (e.g., a mobile or stationary structure or device), sometimes referred to as an asset (i.e., asset tracking and monitoring).

The mobile tracking device 102 includes a processor (e.g., controller) 120, a wireless network module 122 (such as a GSM/GPRS/EDGE modem), a GPS module 124, one or more sensors 126, memory 128, and a power source 130, such as a battery. Various different types (e.g., lithium-ion, nickel-cadmium, etc.), physical sizes and/or capacities (power ratings) of batteries may be used, and the battery 130 may be chosen based on the desired application. Once chosen, the power capacity becomes known. In one embodiment, the battery 130 is non-rechargeable and is permanent (or may possibly be replaceable), and in another embodiment the battery 130 is rechargeable (at least under certain conditions), and in either may be a primary cell battery or a secondary cell battery.

The memory 128 may include and store various data and settings 118, including programmable operating parameters. The device 102 may include a real-time clock and other components (none shown) for providing additional functionality. The one or more sensors 126 may include sensors that measure/sense motion, temperature, velocity, presence or absence of a particular element, or include other functionality for performing any other task.

The GPS module 124 (which includes a GPS receiver, not shown) receives satellite communications from one or more GPS satellites 104 and calculates GPS position/location information. One example of a suitable GPS module (which includes a GSM module) is available from Enfora, Inc. under part number LPP0108. In a different embodiment, other location determining modules and/or methods may be used, such as position triangulation using one or more base stations or other reference points. The wireless network (or communications) module or modem 122 (including a transceiver, not shown) provides wireless communication functionality between the GPS tracking device 102 and the base station 106 and/or host server 108, including transmitting position/location information, such as GPS data, to a remote device (e.g., host server or computer processing system 108). Wireless network module 122 may use any technology including, but not limited to, code division multiple access (CDMA), global system for mobile (GSM) communications, worldwide interoperability for microwave access (WiMAX), or any other wireless standard, or any other technique, scheme, or method of wirelessly transferring data. One example of a suitable communications module is available from Enfora, Inc. under part number GSM0308. In other embodiments, the module 122 may be a network interface for wired communications.

GPS satellite(s) 104 is intended to represent any device that can provide location information to the mobile tracking unit 102, and may utilize any transmission technique known to one skilled in the art, including, but not limited to GPS. It is understood that in the embodiment where satellites 104 are GPS satellites, a number of satellites (usually three) will be required to determine the location of the mobile tracking unit 102. The block identified by numeral 104 may also be another device or devices that provide information to the unit 102 enabling the unit 102 to determine its location.

Power management and consumption information, as well as device operating parameters, may also be communicated between the host server 108 and the GPS tracking device 102.

The network 110 may include one or more local area networks (“LAN”), metropolitan area networks (“MAN”), wide area networks (“WAN”), all or portions of a global network, or any other communication system or systems at one or more locations, or combination of these, including the public switched telephone network (PSTN), Internet, packet networks and the like.

The system 100 shown in FIG. 1 is for illustration purposes only. Other embodiments of the system 100 may be used without departing from the scope of this disclosure. Other components, devices or networks may be included in the system 100, and FIG. 1 only illustrates but one exemplary configuration to assist in describing the system and operation of apparatus and methods described herein to those skilled in the art. The system represented in FIG. 1 may be described using different nomenclature or system terminology, and the use of any given nomenclature to describe a device within the system 100 is not intended to limit the scope of this disclosure.

One of the problems in the transmission of data from the mobile tracking unit 102 to the base station 106 is the substantial power requirements needed to register with the GSM network. Depending on the location of the unit 102 in relation to the base station 106, these power requirements change. For example, being farther away from the base station 106 will require increased power for communications. Indeed, at certain distances, a communication link may not be able to be established. In addition, the majority of the power consumption necessary to determine the unit's location from using the GPS satellites 104 occurs from the acquisition and receipt of the GPS signals. In order to reduce power usage, the present disclosure provides systems and methods which allow for the reduction of timeouts (early termination of the process) in signal acquisition and network registration processes.

As previously described, in one embodiment the mobile tracking unit 102 typically will include at least one non-rechargeable battery 130 used to power the wireless network module 122, the GPS module 124, the processor 120, and etc. This battery 130 has a finite amount of life and consequently needs to be conserved. In order to conserve power within the mobile tracking unit 102, systems and methods which govern how mobile tracking unit 102 initiates or makes connections with various remote devices, including GPS satellites 104 and base station 106, are needed.

Referring back to FIG. 1, the mobile tracking unit 102 includes a power optimization module 150 which includes parameters and/or rules for controlling when and how the mobile tracking unit 102 performs certain tasks or functions. These certain tasks or functions include, but are not limited to, the registration with a base station, transfer of data to a base station, acquisition of GPS location signals or other location information, and acquisition of sensor information. In one embodiment, this is implemented through a set of parameters, rules and/or functions that control how and when (1) a communication link is established between the mobile tracking unit 102 and the base station 106 or network 110 when a data signal is desired to be communicated from the unit 102 (registration process) and/or (2) navigation signals are accessed or otherwise acquired at the unit 102 for use in determining location (acquisition process). It will be understood that use of the term “registration process” herein can mean initial registration of the tracking unit 102 with a wireless (or wired) network and may also mean the transfer of data to a remote device.

For the purpose of clarity, one example each of a data signal (communication of data) and a navigation signal (acquisition of navigation signals) are disclosed herein. These examples are not intended to be limiting, and any technology or standard known to one skilled in the art consistent with the teachings disclosed herein may be used.

One example of a data signal is a wireless signal transmitted over GSM. Currently, in prior art embodiments, a conventional default timeout period is used with the registration process between the mobile tracking device 102 with the GSM network (106, 110). Typically, this timeout period is on the order of four (4) minutes or more. This means that the mobile tracking device 102 will continuously attempt to establish a communications connection (session or link) with the GSM network for four minutes. Only a successful registration on a home or roaming network will prevent a timeout.

In the case of the default timeout setting, the mobile tracking device 102 will continue or maintain operation of the wireless network module (modem) 122 until the timeout event condition occurs, even in the complete absence of GSM signals. In situations where the GSM signals are virtually nonexistent or too weak to allow the establishment of a GSM connection (successful registration process), the device 102 continually attempts to register until the timeout period has ended, and this needlessly consumes power.

In accordance with the teachings of the present disclosure, termination conditions can be defined which, when met, reduce the timeout period or otherwise override the default timeout period. This enables the running process to terminate earlier than the normal termination according to the default timeout setting, thus saving power. Generically, termination conditions are those conditions which, when present, evidence a relatively low likelihood of establishing the GSM connection. Various methods for detecting or determining a termination condition may be implemented. In most embodiments, measurement or assessment of one or more signals received by the unit 102 from a remote device are utilized.

For example, during the registration process, one or more parameters of the signals received from the base station 106 are measured (and/or calculated), such as strength, power, noise, signal-to-noise ratio (SNR), availability of frequencies for data carriers, etc. In the acquisition process, one or more parameters of the navigation signals received from the GPS satellites 104 are measured (and/or calculated), such as strength, power, noise, signal-to-noise ratio (SNR), carrier-to-noise ratio (CNR), number of satellites having available navigation signals, synchronization, etc. Those of ordinary skill in the art will be able to readily identify those parameters of received signals that may be utilized in making a determination that a termination condition has occurred or should occur. As will be appreciated, historical information and device operating conditions may also be used in making the determination (as will be described below).

As an example of one possible terminating condition, during negotiation and setup of a GSM connection, the power optimization module 150 may send an “AT+CREG?” command to the wireless network module 122. The response to this command may indicate that the wireless network module 122 has been denied access to the network due to lack of synchronization. For example, if the response to the power optimization module 150 returns a +CREG value of 3, this indicates that registration process was attempted three times but failed due to lack of synchronization. If the value is 3 or more, then the power optimization module 150 triggers an abort (early termination) of the registration process. In another example, the wireless network module 122 may measure (during the registration process) the power or strength of pilot or other signals generated by the base station 106. If the power is below a predetermined threshold, the power optimization module 150 triggers an abort (early termination) of the registration process.

As will be appreciated, the power optimization module 150 (and its functions) may be embodied within a separate component within the unit 102 (as shown in FIG. 1), may be integrated within another component within the unit 102, or may be integrated into multiple components within the unit 102. In one embodiment, the power optimization module 150 may be composed of logic circuitry, software, firmware, or a combination thereof. In one embodiment, the power optimization module 150 is implemented as a separate microcontroller coupled to a communications bus within the unit 102, and in another embodiment the power optimization module 150 is implemented as software or firmware running on the processor 120.

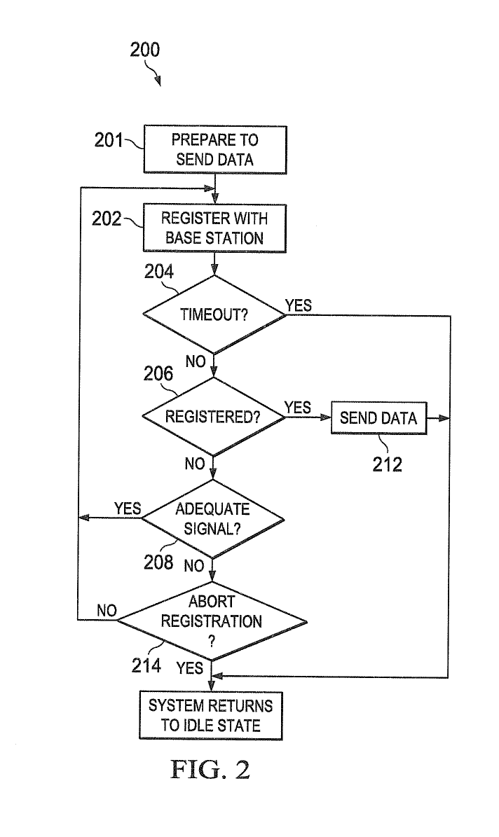

FIG. 2 is a flowchart illustrating a process or method 200 of transmitting data from the unit 102 to a remote device (referred to as the “data signal method”). When a particular event occurs which requires data transmission, the data is prepared (block 201). The device 102 initiates the registration process for registering and/or establishing a communications link or session between the wireless network module 122 and the base station 106 (block 202). This process can be over any appropriate wireless network, including but not limited to GSM, WiFi and WiMax.

In accordance with the teachings herein, the registration process is periodically monitored. When the default timeout event occurs, the registration process is terminated (block 204). If the registration process is successful (i.e., establishing an operable connection between the device 102 and the base station 106) (block 206), the data is transmitted to the base station 106 (block 212).

During monitoring, in the event a successful registration has not occurred yet, the device 102 monitors one or more operating parameters or conditions to determine whether a termination condition or event has occurred. For example, this may include monitoring the signaling conditions (as described previously and below) between the base station 106 and the device 102 to determine whether adequate base station signals exist (block 208). If adequate signaling exists, the registration process is continued until the registration process is successful (block 206) or the default timeout event occurs (block 204). If adequate signaling does not exist, a decision is made on whether to early terminate the registration process in block 214.

As will be appreciated, multiple parameters or conditions can be monitored during the registration process at multiple times, and monitoring of a particular parameter(s) or condition(s) may be done more than once. When a predetermined threshold for a monitored parameter or condition is met, a “termination condition” has occurred and the registration process is (or may be) early terminated (regardless of whether the default timeout has occurred).

Various termination conditions can be utilized, including failing to achieve synchronization, low signal strength, SNR, CNR, low number of signals (e.g., not enough GPS satellite signals), or network specific criteria. Other termination conditions can be utilized. In addition, a decision to early terminate the registration process can be based upon device history, operational environment and/or other device or network specific criteria.

One example of a decision criterion involves implementing an additional counter in the power optimization module 150 for tracking the number of consecutive registration processes that have been terminated. This counter can be used to specify how many consecutive early terminations are allowed before spending the full amount of the registration process timeout to find a signal. Another example involves waiting a predetermined time period before allowing an early termination, allowing for temporary events, such as entering tunnels, to be handled appropriately. A third example involves extending this predetermined time period if a previous attempt to register was successful, under the assumption of correlation between adjacent attempts to register to the network. If the current registration attempt is successful, then it is possible the next registration attempt should be successful more frequently than if not. Other parameters or conditions may be suitably considered in the process of determining to early terminate the registration (or acquisition) process. As will be appreciated, this method 200 may be useful for navigation signals also.

Turning now to navigation signals, one example is GPS signals. Currently in the art, the process of acquiring a GPS navigation fix includes a default timeout condition, where the timeout period is determined based upon typical performance. Only a successful fix will prevent a timeout. For example, in a scenario in which the device 102 is located within a shielded container, the device 102 will continue operation of the GPS module 124 for the full default timeout period regardless of GPS signal availability. As with data signal transmissions (e.g., the data signal method), certain termination conditions can be defined to reduce this time period and initiate early termination of the GPS signal acquisition process.

In one embodiment, a GPS acquisition termination condition can be defined based upon the lack of incremental progress in acquiring one or more signals. One example of this is determining whether signal level (e.g., power, SNR, etc.) rises above a predetermined threshold for a predefined number of satellites within predefined time windows. In this case, the GPS module's 124 satellite measurement status and Carrier to Noise Ratio (CNR) can be monitored during the acquisition phase in a measurement status packet. CNR is typically monitored for all satellites. For example, in the event a satellite having signal strength of greater than a predetermined threshold is not seen within the first one (1) minute, the acquisition process can be early terminated or considered for early termination. Similarly, if two (2) satellites having signal strengths greater than a predetermined threshold are not seen in the first two (2) minutes, the acquisition process can be early terminated or considered for early termination. If three (3) satellites having signal strengths of greater than a predetermined threshold are not seen in the first three (3) minutes, the acquisition process can be early terminated or considered for early termination. Other suitable termination conditions can be defined and utilized based on signal measurements.

In another embodiment, a GPS termination condition can be defined based on whether data synchronization occurs to a predefined number of satellites within a predefined time window. In this embodiment, the synchronization state of the GPS module 124 is monitored during the acquisition process. For example, in the event synchronization with one satellite is not achieved in the first one (1) minute, the acquisition process can be early terminated or considered for early termination. If synchronization with two (2) satellites is not achieved in the first two (2) minutes, the acquisition process can be early terminated or considered for early termination. If synchronization with three (3) satellites is not achieved in the first three (3) minutes, the acquisition process can be early terminated or considered for early termination.

In addition, in other embodiments, the decision to early terminate an acquisition process may also be based on analyzing device history. For example, a counter is maintained that keeps track of the number of consecutive acquisition processes that have been early terminated. This counter can used to specify how many consecutive early terminations are allowed before spending the full amount of the acquisition timeout to find a GPS fix (acquisition process).

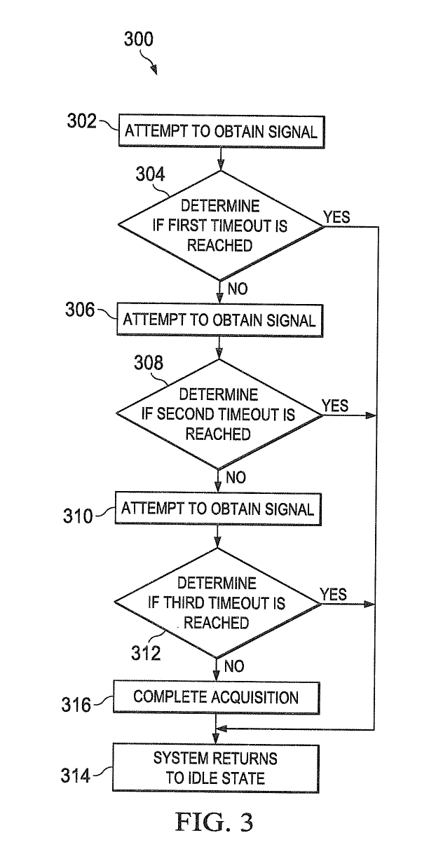

FIG. 3 is a flowchart illustrating a process or method 300 of acquiring navigation signals at the unit 102 from GPS satellites 104 (or other navigation signal generating device) (referred to as the “navigation signal method”). When a particular event occurs which requires acquisition of navigation signals, the GPS module 124 begins the acquisition process (block 302). A determination is made whether a first timeout is reached without at least one satellite having adequate signal strength for possible acquisition (block 304). If no satellites are found having adequate signal strength during the first timeout period, the acquisition process is early terminated and proceeds to an idle state (block 314). Otherwise the acquisition process continues (block 306). A determination is made whether a second timeout is reached without at least two satellites having adequate signal strength for possible acquisition (block 308). If less than two satellites are found having adequate signal strength during the second timeout period, the acquisition process is early terminated and proceeds to an idle state (block 314). Otherwise the acquisition process continues (block 310). Next, a determination is made whether a third timeout is reached without at least three satellites having adequate signal strength for possible acquisition (block 312). If less than three satellites are found having adequate signal strength during the third timeout period, the acquisition process is early terminated and proceeds to an idle state (block 314). Otherwise the acquisition process continues (block 316) and the process will be either (1) successful or (2) the default timeout period is reached (i.e., normal termination) and the process proceeds to the idle state.

There may also be an assumed correlation between adjacent attempts to acquire GPS signals, meaning that if the current acquisition process attempt is successful, then the next acquisition process attempt has a higher probability of success. In one embodiment, this correlation can be used to allow the GPS acquisition process to wait the full default timeout period prior to it being terminated following a prior successful acquisition process(es). In another example, based on the history of whether prior acquisition processes were successful, the first, second and third timeout periods may be adjusted one way or the other (increased or decreased).

As will be appreciated, multiple parameters or conditions can be monitored during the navigation signals acquisition process at multiple times, and monitoring of a particular parameter(s) or condition(s) may be done more than once. When a predetermined threshold for a monitored parameter or condition is met, a “termination condition” has occurred and the acquisition process is (or may be) early terminated (regardless of whether the default timeout has occurred).

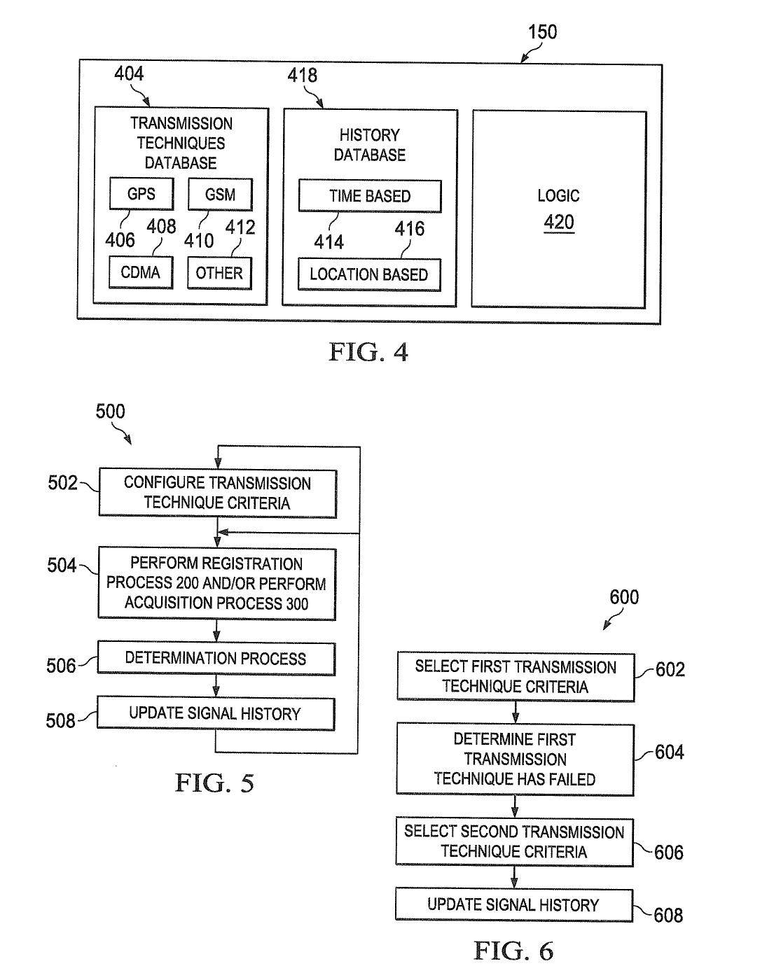

Now turning to FIG. 4, there is shown a block diagram of the power optimization module 150 for implementing the teachings herein. The power optimization module 150 includes a transmission techniques database 404, a history database 418, and logic 420. The phrase “transmission techniques” is intended to refer to any scheme used to transmit or receive data, including those explicitly named or described herein.

Transmission techniques database 404 includes information related to various transmission techniques. In the example illustrated in FIG. 4, these techniques include GPS information 406, CDMA information 408, GSM information 410, and other information 412. This information may include a plurality of parameters or data, including, but not limited to, the timeout(s) for a particular protocol and/or technology specific successful acquisition process criteria or registration process.

History database 418 includes time-based information 414 and location-based information 416 (and may include other types of information not explicitly shown). Time-based information 414 may provide a history of successes and/or failures (e.g., for registration process and acquisition process). Similarly, location-based information 416 may provide location data associated to or with previous successful and unsuccessful registration (i.e. connection) and acquisition processes. One of the unique and novel elements of the present disclosure is to be able to use this history to predict the probability of a future successful (or unsuccessful) process.

Logic 420 (embodied as either the processor 120 or a separate processor 420 operating with firmware/software) interprets information from the transmission techniques database 404 and the history database 418 and determines or adjusts parameters within the transmission techniques databases. It will also be understood that the information in the databases 404, 418 may be stored in the settings 118 of the memory 128 in the device 102.

During the particular process (e.g., registration or acquisition), the power optimization module 150 monitors, measures or receives information about the operating parameters and conditions (as described above) associated with the particular process at issue. If a particular predetermined threshold is met, the power optimization module 150 issues an early termination command to the appropriate module 122, 124 which causes the process to early terminate. In another embodiment, the power optimization module 150 may also consider history information in the database 418 in making the determination to early terminate the process.

Any suitable method of ascertaining the operating parameters and conditions associated with the particular process may be utilized. In one embodiment, the wireless network module 122 and GPS module 124 operate in accordance with a standard or proprietary interface having multiple commands and responses. In this manner, the power optimization module 150 can simply issue a command (such as an AT command) requesting certain information that generally readily available for output by the particular module 122, 124. For example, the module 150 sends a particular command to the module 122, 124 seeking information about the received signals. In response, the module 122, 124 sends this information, and the power optimization module compares this information to the predetermined threshold(s). In another embodiment, the wireless network module 122 and GPS module 124 can be configured to periodically store (in memory) certain parameters and conditions as measured or generated during performance of its particular process. The module 150 can then simply access the memory at any time and compare this information with the predetermined threshold(s).

Now turning to FIG. 5, there is illustrated a method or process 500 of reducing or minimizing power consumption in the device 102. Generally, this is accomplished by monitoring or measuring various operating parameters or conditions during the registration process and/or acquisition process and early terminating that process when there is a relatively low likelihood of successful completion of that process.

At some point in time, a conventional default timeout period and various transmission technique criteria (i.e., the predetermined signal parameter thresholds used to determine a termination condition is met) are initially chosen, set or configured (block 502) for both the registration process and the acquisition process. During operation of the device 102, initiation of the data signal registration process 200 and the navigation signal acquisition process 300 occur normally in accordance with the operating program of the device 102 (block 504). However, instead of relying on a default timeout setting of each process to terminate the process when it is unsuccessful due to the default timeout period being reached, the registration and acquisition processes (described above with reference to FIGS. 2 and 3) are monitored utilizing various operating conditions or parameters involved in the process to early terminate the process (i.e., terminate the process before the default timeout). In this manner, when the likelihood of the process being successful during the default timeout period is relatively low, the particular process can be terminated early to save power. As will be appreciated, the operating conditions or parameters involved in the process may be any of those described in the present disclosure and other conditions or parameters that could be useful and understood by those skilled in the art.

During execution of the particular registration or acquisition process, a determination process occurs to determine whether to early terminate the particular process, and if so, the process is terminated (step 506). This determination process includes monitoring or determining the operating signal condition(s) or parameter(s) of the particular process, comparing these to one or more predetermined signal threshold(s), and causing early termination of the process based on the comparison. Though not shown, this process may also consider as factors various history information (described above) in making the determination to early terminate the process.

After each of the processes 200, 300 are performed (and ended), the result of the process is recorded and the history database 418 is updated (block 508). As will be appreciated, the registration process 200 and the acquisition process 300 may be independent or dependent on each other (depending on the desired operation of the device 102) and after each process is either completed or terminated, this information is updated into the history database 418.

Thereafter, the updated signal history may result in the transmission technique criteria being changed or modified 9 and the method 500 waits until the next registration process or acquisition process is initiated and performed (block 504). If no change or modification is necessary, the method 500 may continue to block 504 and perform the next registration or acquisition process according to the operating program of the device 102.

A different method 600 of saving power is illustrated in FIG. 6, where at least two specific registration processes (or navigation signal acquisition processes) are utilized and prioritized. In the example shown, a first transmission technique is used followed by a second transmission technique. For exemplary purposes only, the first registration (connection) process involves a WiFi signal and the second registration process (connection) involves a GSM signal.

The first transmission technique is selected and initiated (block 602). If the event this WiFi registration process cannot be successfully completed quickly (or in accordance with any other parameter or condition defined that may assist in reducing power) (block 604), it may be more efficient to abandon the WiFi registration process and initiate the registration process with the GSM network (block 606). Thus, if there is a failure in the first transmission technique, a second transmission technique can be selected and initiated. The second registration (connection) process is initiated and a connection attempt is made. Whether successful or unsuccessful, the signal history is updated (block 608). This can also be done for the first attempted registration process.

Though not specifically shown, the process of FIG. 6 is also applicable to navigation signal acquisition processes. The first technique (GPS signal acquisition process) is selected and initiated. If the GPS signals cannot be successfully acquired quickly (or in accordance with any other parameter or condition defined that may assist in reducing power), it may be more efficient to early terminate the GPS acquisition process and initiate a second navigation signal acquisition process that acquires location information from the GSM network.

It is understood that a special termination condition, such as a short timeout or other condition, may trigger the switch from the first to the second transmission technique.

Although the figures above illustrate specific systems, structures, and methods, various changes may be made to the figures. For example, various components in the systems and structures can be combined, omitted, further subdivided, or moved according to particular needs. Also, while shown as a series of steps, various steps in FIG. 6 could overlap, occur in parallel, or occur multiple times.

In some embodiments, the logic for carrying out the functions described above may be encoded in software, hardware, or a combination of software or hardware. The software or hardware may supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The term “couple” and its derivatives refer to any direct or indirect communication between two or more elements, whether or not those elements are in physical contact with one another. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method of reducing power consumption in a module within a mobile tracking device operable within a wireless communication network, the method comprising:
initiating a process performed by the module, the process configured for performing a predetermined operation within the mobile tracking device, the process configured with a default timeout period during which the module continues to attempt to perform the predetermined operation;
measuring a parameter of a signal transmitted from a remote device during the process;
comparing the measured parameter to a predetermined threshold; and
determining that the measured parameter does not meet the predetermined threshold and terminating the process prior to the default timeout period.

2. The method in accordance with claim 1 wherein the parameter is at least a one of: signal strength, power, signal-to-noise ratio, or signal synchronicity.

3. The method in accordance with claim 1 wherein the wireless communication network is a GSM network and the process is a registration process operable for establishing a communication link with a remote base station.

4. The method in accordance with claim 1 wherein the process is an acquisition process operable for determining a location of the mobile tracking device using navigation signals.

5. The method in accordance with claim 4 wherein the parameter is at least a one of the following: signal synchronicity or presence of at least three different GPS signals.

6. The method in accordance with claim 4 wherein the parameter is at least a one of the following: signal strength, power, signal-to-noise ratio, or carrier-to-noise ratio.

7. The method in accordance with claim 1 wherein determining that the measured parameter does not meet the predetermined threshold and terminating the process prior to the default timeout period further comprises:
after determining that the measured parameter does not meet the predetermined threshold, terminating the process after a predetermined period of time elapses but prior to the default timeout period, the predetermined period of time based at least in part on history information of the process.

8. The method in accordance with claim 7 wherein the parameter is at least a one of: signal strength, power, signal-to-noise ratio, signal synchronicity.

9. The method in accordance with claim 7 wherein the wireless communication network is a GSM network and the process is a registration process operable for establishing a communication link with a remote base station.

10. The method in accordance with claim 7 wherein the process is an acquisition process operable for determining a location of the mobile tracking device using navigation signals.

11. A method of reducing power consumption in a GPS module within a mobile tracking device operable within a wireless communication network, the method comprising:
initiating a GPS signal acquisition process performed by the GPS module, the process configured for performing acquiring GPS signals and determining a location of the mobile tracking device, the process further configured with a default timeout period during which the module continues to attempt to perform the predetermined operation; and
determining within a first predetermined time interval if a first predetermined number of GPS satellite signals have been acquired, and if not, then early terminate the process, and if so, determining within a second predetermined time interval if a second predetermined number of GPS satellite signals have been acquired, and if not, then early terminate the process, and if so, continue with the process.

12. The method in accordance with claim 11 further comprising:
determining within a third predetermined time interval if a third predetermined number of GPS satellite signals have been acquired, and if not, then early terminate the process, and if so, continue the process.

13. The method in accordance with claim 11 wherein the first predetermined number equals one and the second predetermined number equals two or three.

14. A mobile tracking device comprising:
a wireless network module having a wireless transceiver device configured for wirelessly communicating with a remote device, the wireless network module configured to perform a registration process operable for establishing a communication link with the remote device;
a location generating module having a GPS receiver device configured for receiving GPS signals from one or more GPS satellites, the location generating module configured to perform a GPS signals acquisition process operable for acquiring multiple GPS signals and determining a location of the mobile tracking device therefrom; and
a power optimization module configured to early terminate either the registration process or the GPS signals acquisition process based on at least one measured parameter of either a signal transmitted from the remote device during the registration process or a GPS signal transmitted from a GPS satellite during the GPS signals acquisition process, respectively.
